(19) United States
(12) Patent Application Publication
(10) Pub. No.: US 2006/0103516 A1
(43) Pub. Date: May 18, 2006

(54) Infant car seat alarm system and method

(76) Inventor: De Yu Zang, Irvine, CA (US)

Correspondence Address: De Yu Zang, 11 Lassen, Irvine, CA, 92612, US

(21) Appl. No.: 11/271,030

(22) Filed: Nov. 12, 2005

Related U.S. Application Data
(60) Provisional application No. 60/627,680, filed on Nov. 15, 2004.

(51) Int. Cl. B60Q 1/00

(52) U.S. Cl. 340/457

(57) ABSTRACT

A system comprises a detector for detecting the presence of an occupant, an alarm for generating an alarm signal, a sensor for detecting an ambient condition, a receiver for detecting a predetermined RF signal, and a controller connected to the sensor, the receiver, the detector, and the alarm for causing the alarm to generate the alarm signal when the presence of an occupant has been detected and one or both of the predetermined RF signal is detected or a predetermined ambient condition is detected.

### RELATED APPLICATIONS

This patent application claims the priority of U.S. Provisional Patent Application Ser. No. 60/627,680 filed on Nov. 15, 2004, the entire contents of which are incorporated herein by reference thereto.

### TECHNICAL FIELD

This disclosure relates to safety systems for infant car seats and more particularly to alarms for alerting to the presence of an occupant in an infant car seat under certain conditions.

### BACKGROUND

Baby car seats are widely used as they are required by law when transporting children in vehicles. According to published statistics, 50-60 children die of hyperthermia or hypothermia each year because they were left unattended in vehicles. Attempting to avoid such tragedies, various systems for warning responsible parties that children have been left behind in a baby car seat have been proposed, and are described, inter alia, in U.S. Pat. Nos. 5,581,234; 5,949,340; 5,966,070; 6,104,293, and U.S. patent publication No. 2003/0122662. These systems have rather complex installation and equipment requirements, such as interfacing with the vehicle's alarm system and/or electric system, and thus are not overly cost effective. This has been proven in the marketplace as these systems have not gained wide-spread use and otherwise avoidable infant deaths tragically continue to occur.

Therefore, a continuing need exists for practical systems and methods for warning adults that children have been left unattended in a vehicle before hypothermic conditions occur. The systems will ideally be inexpensive to produce and easy to install. The embodiments of the present disclosure answer these and other needs.

### SUMMARY

In a first embodiment disclosed herein, a system comprises a detector for detecting the presence of an occupant, an alarm for generating an alarm signal, a sensor for detecting an ambient condition, a receiver for detecting a predetermined RF signal, and a controller connected to the sensor, the receiver, the detector, and the alarm for causing the alarm to generate the alarm signal when the presence of an occupant has been detected and one or both of the predetermined RF signal is detected and a predetermined ambient condition is detected.

In another embodiment disclosed herein, a method comprises monitoring the presence of an occupant in a vehicle, monitoring one or more preselected ambient conditions, monitoring the emission of a predetermined RF signal, and generating an alarm signal when the presence of an occupant has been detected and one or both of the predetermined RF signal is detected and a preselected ambient condition is detected.

In a further embodiment disclosed herein, the predetermined ambient condition may be selected from among the group of conditions comprised of the ambient temperature exceeding a preselected upper threshold, the ambient temperature falling below a preselected lower threshold, and no ambient vibrations being detected. The system may be activated or the method may be initiated upon the closure of a seat buckle.

These and other features and advantages will become further apparent from the detailed description and accompanying figures that follow. In the figures and description, numerals indicate the various features, like numerals referring to like features throughout both the drawings and the description.

### BRIEF DESCRIPTION OF THE DRAWINGS

FIG. 1 is a functional block diagram of a system according to the present disclosure;

FIG. 2 is a flow chart of a method of operation of the system of FIG. 1; and

FIG. 3 is a flow chart of a method of operation of the system of FIG. 1.

### DETAILED DESCRIPTION

At its broadest, the present disclosure contemplates an alarm system to be used with an infant car seat that is operational as long as an infant or child is detected as being present in the seat and that, while operational, monitors certain environmental variables and issues an alarm when one or more of these variables meet certain conditions. More specifically, the alarm monitors at least one of the ambient temperature around the car seat, vibrations experienced by the car seat, and the emission of RF signals corresponding to the signal transmitted by vehicle remote (keyless) entry devices.

Monitoring the ambient temperature provides an indication if the temperature inside the vehicle approaches a predetermined, dangerous level, and can include both an upper threshold and a lower threshold at which to issue an alarm. Monitoring the vibrations experienced by the car seat provides an indication of whether the vehicle engine is running or not. Monitoring RF signals that correspond to the signal transmitted by vehicle remote (keyless) entry devices is an easy way to monitor whether the doors of the vehicle may have been locked or not. The presence of a child in the seat may further be monitored by detecting whether the infant car seat buckle is fastened or not. As the skilled reader will appreciate, certain combinations of these variables can thus provide a reliable indication that the driver of a vehicle has left the car with a child inside of it, and that an alarm should be issued.

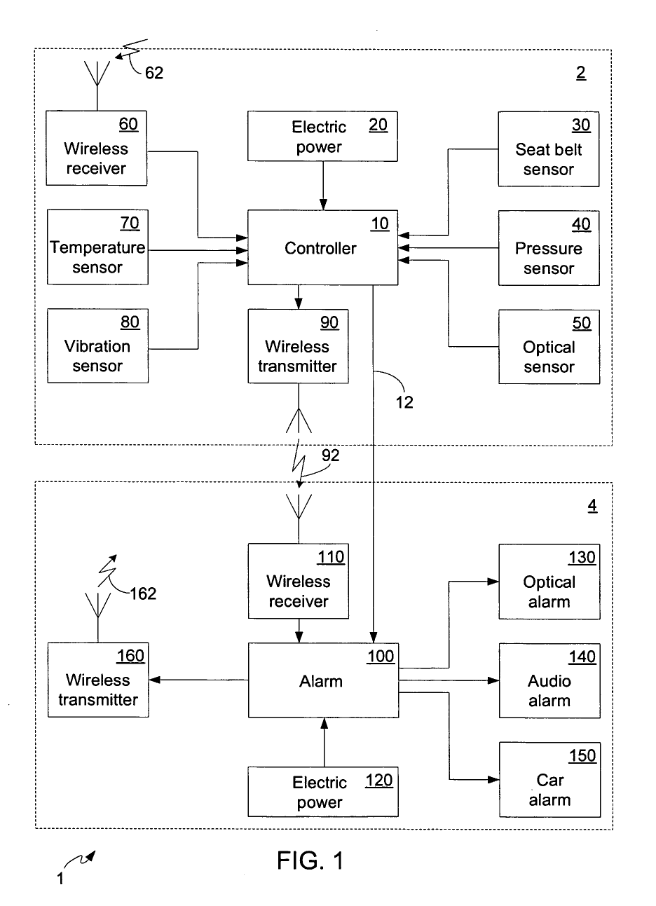

Referring to FIG. 1, one possible embodiment of a system 1 according to the present disclosure is shown as divided into two functional blocks, a controller block 2 and an alarm block 4. It must be understood that the invention contemplates all possible hardware configurations for the functional elements described herein, whether in a single device, two or more separate devices, or any other practicable configuration. The present embodiment of FIG. 1 is therefore presented solely for purposes of discussion and illustration of the inventive concepts disclosed herein.

With continued reference to FIG. 1, the two functional blocks 1, 2 represent the two main functions of a system in accordance with the present disclosure, namely detection and alarm. Detection is accomplished by the controller 10, which receives input from a variety of sensors, shown in the present embodiment to include a seat belt sensor 30, pressure sensor 40, optical sensor 50, wireless receiver 60, temperature sensor 70, and vibration sensor 80. The seat belt sensor 30, pressure sensor 40, optical sensor 50 are preferably mounted on the car seat itself and are provided for detecting the presence of a child in the seat. The wireless receiver 60, temperature sensor 70, and vibration sensor 80 may be mounted anywhere in the vicinity of the seat, although for reasons of practicality they are most likely to be mounted within the same device as the rest of the elements comprising the controller block 1.

The seat belt sensor may take the form of a switch that completes a circuit when the car seat safety belt is buckled. The optical sensor 50 may be an infrared sensor or any other type of sensor that will detect that a child has been placed in the seat. Thus, it will be appreciated that the optical sensor 50 and the pressure sensor 40 are essentially redundant, and only one of these sensors may be chosen to be employed in accordance with the present disclosure.

The wireless receiver may take the form of a universal wireless receiver that typically covers a wide frequency range of RF signals, and can thus detect the RF signals 62 emitted by any vehicle remote entry device from any vehicle or after-market manufacturer. The temperature sensor 70 is provided for detecting the ambient temperature round the car seat, i.e. inside the car. The vibration detector 80 is provided for detecting engine vibrations and thus providing an indication of whether the engine is running or has been turned off.

As shown, the controller 10 is supplied with electric power by a power supply 20, which may comprise a battery pack, a solar cell, or the vehicle's power system. The controller 10, in turn, may supply the power required by the sensors and wireless transmitter 90 and receiver 60.

The alarm function is controlled by the alarm 100, which receives an alarm signal 92 from the controller. The signal may be transmitted wirelessly by a wireless transmitter 90 connected to the controller, or via a hard link 12 such as a wire or an optical fiber. The wireless transmitter 90 may transmit an RF signal or an optical (such as IR) alert signal 92. The alarm wireless receiver 110 is selected to be able to receive the alert signal 92 generated by the controller 10 and to provide it to alarm 100. The alarm 100 is selected to generate a signal to drive one or more alarm devices, which are shown for purposes of illustration only to include an optical alarm 130, audio alarm 140, and an alarm system 150 already built into the vehicle. The optical alarm may include one or more lights that may light or flash. The audio alarm will typically comprise one or more speakers that generate an alert sound, which may be a typical siren sound or even a spoken voice message alerting passers-by. If connected to the car alarm 150, the alarm 100 can cause the vehicle alarm system to be activated, which can typically include flashing the headlights and turn signals of the vehicle, actuating a speaker for generating a loud alarm sound or spoken voice message, and/or honking the vehicle horn.

The alarm may also be provided to actuate a wireless transmitter 160 to generate a wireless signal 162 for remotely alerting the user, such as by contacting the user on the user's cellular telephone or mobile pager (not shown).

As shown, the alarm 100 is supplied with electric power by a power supply 120, which may comprise a battery pack, a solar cell, or the vehicle's power system. The alarm 100, in turn, may supply the power required by the wireless transmitter 160 and receiver 110.

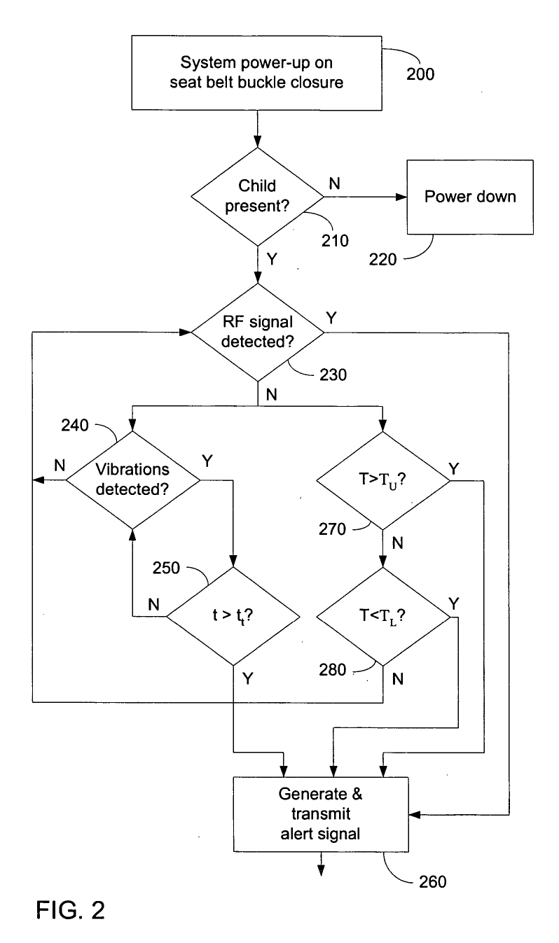

In a method of operation of the above-described embodiment, and with reference now to FIG. 2, the system 1 of the present disclosure is preferably powered-up 200 upon closure of the safety belt buckle on the car seat as detected by the seat belt sensor 30, which typically indicates that an occupant (i.e. child) has been placed in the seat. This is next confirmed 210 by a presence detector such as pressure sensor 40 and/or optical sensor 50, which places the system 1 into stand-by mode. In stand-by mode, the system 1 monitors 210 continuously the presence detectors 40, 50 to ensure that the child is still in the seat, monitors 230 the wireless receiver 60, and monitors 240 the vibration sensor 80 to ensure that the car engine is running (and thus presumably indicative of the driver being in the car or at least being only temporarily out of the car and intending to return shortly), and continuously monitors. Upon a signal 62 being detected by the wireless receiver indicative of the vehicle remote entry device being used to lock the vehicle doors, the controller generates and transmits 260 an alert signal 92 to be received by the alarm 100.

When the vibration sensor 80 stops detecting vibrations, the system 1 assumes that the vehicle has been stopped permanently and enters an alert mode wherein it first counts down 250 for a predetermined length of time tₜ and then, if no vibrations are detected (i.e. the engine is still off), the system assumes that the driver has walked away permanently from the car with the child still inside and the controller generates and transmits 260 an alert signal 92 to be received by the alarm 100. In the alert mode the controller also begins to monitor 270, 280 the temperature sensor 70. Upon the temperature inside the car as measured by the temperature sensor reaching either an upper threshold T_{U} (such as, e.g., 90° F.) or a lower threshold T_{L} (such as, e.g., 50° F.), the controller again generates and transmits 260 an alert signal 92 to be received by the alarm 100.

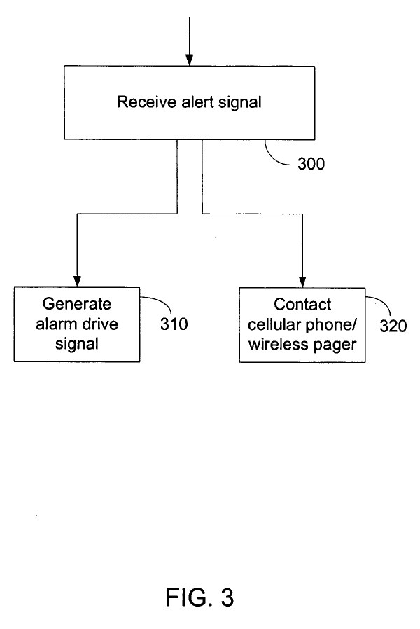

With reference now to FIG. 3, upon receipt 300 by the alarm wireless receiver 110 of an alert signal 92 from the controller wireless transmitter 90 or alternatively upon receipt by the alarm 100 of an alert signal 92 from the controller 10, the alarm 100 generates 310 an alarm signal to drive one or more alarms as previously discussed. Also as previously mentioned, the alarm 100 may also be programmed to activate 320 a wireless transmitter 160 to generate a wireless alarm signal, such as a call to a cellular telephone or wireless pager (e.g. the cell phone or pager of the driver) to deliver a message such as a spoken voice message or a text message to the driver alerting to the fact that the child has been left behind in the vehicle and in dangerous conditions.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

What is claimed is:

1. A system, comprising:
a detector for detecting the presence of an occupant;
an alarm for generating an alarm signal;
a sensor for detecting an ambient condition;
a receiver for detecting a predetermined RF signal; and
a controller connected to the sensor, the receiver, the detector, and the alarm for causing the alarm to generate the alarm signal when the presence of an occupant has been detected and one or both of the predetermined RF signal is detected and a predetermined ambient condition is detected.

2. The system of claim 1, wherein the sensor comprises one or more of a temperature sensor for sensing an ambient temperature and a motion sensor for detecting ambient vibrations.

3. The system of claim 2, wherein the predetermined ambient condition is selected from among the group of conditions comprised of the ambient temperature exceeding a preselected upper threshold, the ambient temperature falling below a preselected lower threshold, and no ambient vibrations being detected.

4. The system of claim 1, further comprising:
an activator for activating the system in response to a predetermined input.

5. The system of claim 4, wherein the activator comprises:
a switch for detecting the closure of a car seat buckle as the predetermined input.

6. The system of claim 1, further comprising:
a power supply for providing electric power to the system.

7. The system of claim 1, wherein the alarm comprises:
an alarm for generating an alarm signal selected from among the group of alarm signals comprised of audible signals, visual signals, and electrical signals.

8. The system of claim 1, wherein the receiver comprises:
a receiver for detecting a wireless signal emitted by a vehicle remote entry device.

9. The system of claim 6, wherein the receiver comprises:
a receiver for detecting an RF signal having a frequency in the range of about 300 MHz to about 500 MHz.

10. The system of claim 4, wherein the detector comprises:
a sensor selected from the group of sensors comprised of pressure sensors, heat sensors, and optical sensors.

11. The system of claim 1, wherein the alarm comprises:
a wireless transmitter for delivering an alarm signal to a preselected cellular telephone number or wireless pager number.

12. A method, comprising:
monitoring the presence of an occupant in a vehicle;
monitoring one or more preselected ambient conditions;
monitoring the emission of a predetermined RF signal; and
generating an alarm signal when the presence of an occupant has been detected and one or both of the predetermined RF signal is detected and a preselected ambient condition is detected.

13. The method of claim 12, wherein monitoring the one or more preselected ambient conditions comprises:
monitoring ambient vibrations in the vehicle indicative of vehicle engine operation; and
upon sensing the cessation of vehicle engine vibrations, monitoring the ambient temperature in the vehicle.

14. The method of claim 12, further comprising:
initiating the method in response to a predetermined input.

15. The method of claim 14, wherein the predetermined input comprises:
detecting the closure of a car seat buckle.

16. The method of claim 12, wherein generating the alarm signal comprises:
generating an alarm signal selected from among the group of alarm signals comprised of audible signals, visual signals, and electrical signals.

17. The method of claim 12, wherein monitoring the emission of the predetermined RF signal comprises:
monitoring the emission of a predetermined RF signal having a frequency in the range of about 300 MHz to about 500 MHz.

18. The method of claim 12, wherein detecting the presence of an occupant comprises:
detecting the presence of an occupant with a sensor selected from the group of sensors comprised of pressure sensors, heat sensors, and optical sensors.

19. The method of claim 12, wherein generating the alarm signal comprises:
delivering an alarm signal to a preselected cellular telephone number or wireless pager number.
